(19) United States
(12) Patent Application Publication
(10) Pub. No.: US 2019/0246289 A1
(43) Pub. Date: Aug. 8, 2019

(54) System And Method To Form An Optimized Repeater Network

(71) Applicant: MediaTek Singapore Pte. Ltd., Singapore (SG)

(72) Inventors: Raghav Monga, Chandigarh (IN); Amit Kumar Shakya, New Delhi (IN); Avishad Verma, Barabanki (IN)

(21) Appl. No.: 15/892,402

(22) Filed: Feb. 8, 2018

(51) Int. Cl. H04W 16/18; H04B 7/15; H04W 24/08; H04W 8/00

(52) U.S. Cl. CPC H04W 16/18; H04W 8/005; H04W 24/08; H04B 7/15

(57) ABSTRACT

Systems and methods to form an optimized repeater network are described. A master node triggers regrouping of a plurality of repeaters in a network of a first topology by performing a number of operations. The master node transmits a discovery request to the plurality of repeaters to cause each repeater of the plurality of repeaters to conduct a scan to detect signal strengths of other repeaters of the plurality of repeaters. The master node receives information on results of the scan from each repeater of the plurality of repeaters. Based on the received information, the master node directs the plurality of repeaters to form a network of a second topology different from the first topology.

### TECHNICAL FIELD

The present disclosure is generally related to computer networking and, more particularly, to systems and methods to form an optimized repeater network.

### BACKGROUND

Unless otherwise indicated herein, approaches described in this section are not prior art to the claims listed below and are not admitted as prior art by inclusion in this section.

In computer networking, a repeater is an electronic device that receives a signal and retransmits the signal at a higher level or higher power so that the signal can be received at a long distance away. Repeaters are devices that can function as both an access point (AP) and a station (STA) (or as both a host and a client), denoted as “repeater_AP” and “repeater_STA” herein, respectively. As a client or repeater_STA, the repeater functions strictly on a channel of repeater_AP, and can connect to another AP and/or repeater_AP. As a host or repeater_AP, a repeater can allow association from other STA's and repeater_STA's. Accordingly, connections between different repeaters can result in mixed topologies such as daisy chain (or line), star, mesh, ring, bus, and so on. When all the repeaters in a network boot up, initial connections may not be optimal as the repeaters do not have the knowledge of the complete environment. As a result, the network formed would depend on the order in which the repeaters boot up.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes, mechanisms, methods and systems that aid repeaters to form an optimal network. For instance, under a proposed scheme, a centralized network control mechanism may be implemented to create an optimal network of repeaters. Moreover, under the proposed scheme, a user may customize the topology of the network of repeaters.

In one aspect, a method may involve triggering regrouping of a plurality of repeaters by performing the following: (1) transmitting, by a master node, an initiating request and a discovery request to a plurality of repeaters in a network of a first topology to cause each repeater of the plurality of repeaters to conduct a scan to detect signal strengths of other repeaters of the plurality of repeaters; (2) receiving, by the master node, information on results of the scan from each repeater of the plurality of repeaters; and (3) directing, by the master node based on the received information, the plurality of repeaters to form a network of a second topology different from the first topology.

In one aspect, a method may involve setting a status of each of a plurality of repeaters to indicate an unprocessed state. The method may also involve parsing a list of the plurality of repeaters to identify one or more first repeaters of the plurality of repeaters such that a respective signal strength between each of the one or more first repeaters and a master node is greater than a threshold. The method may further involve setting the status of each of the one or more first repeaters to indicate a processed state. The method may additionally involve transmitting an address of a target repeater to each of the one or more first repeaters such that each of the one or more first repeaters is connected to the target repeater.

In one aspect, an apparatus may include a communication device and a processor coupled to the communication device. The communication device may be capable of wireless communications with a plurality of repeaters in a network of a first topology. The processor may be capable of regrouping the plurality of repeaters to form a network of a second topology different from the first topology.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme 100 of a multi-way message exchange protocol in accordance with an implementation of the present disclosure.

FIG. 2A˜FIG. 2G are each a diagram of a respective portion of a process under an example scheme in accordance with an implementation of the present disclosure.

FIG. 3A˜FIG. 3B are each a diagram of a respective portion of a process under an example scheme in accordance with an implementation of the present disclosure.

FIG. 4A˜FIG. 4D are each a diagram of a respective portion of a process under an example scheme in accordance with an implementation of the present disclosure.

FIG. 5 is a diagram of an example logic flow in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a simplified block diagram of an example apparatus in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

In various implementations in accordance with the present disclosure, a centralized algorithm may run or otherwise be executed on a master node. The notion of “master node” herein is used to refer to a node that collects information from other nodes of a network and triggers regrouping of the nodes in accordance with various implementations of the present disclosure. Moreover, the notion of “root node” herein is used to refer to the highest node or point on a tree structure, which does not have a parent node but serves as the parent or ‘grandparent’ of all other nodes below it in the tree structure. In the present disclosure, a master node may or may not be a root node before regrouping to form an optimized network in accordance with the present disclosure, but may be the root node after the regrouping. The master node may collect information of all devices (e.g., repeaters) in a network through a multi-way (e.g., four-way) message exchange protocol. Based on the collected information, the master node may determine connections in the network such as, for example, which repeater would connect to which other repeater. The master node may inform a repeater about the target media access control (MAC) address of a target repeater to which the repeater is to connect. The master node may consider regrouping of the repeaters complete once the connections among the repeaters in the network are complete. Regrouping of the repeaters in the network may be triggered automatically by the master node. Regrouping of the repeaters may also be triggered by a user (e.g., a mobile app on a mobile device operated by the user may trigger automatic regrouping on the master node). Alternatively, regrouping of the repeaters may be triggered by a user as the user decides to change the network from a current topology to a new topology.

In various implementations in accordance with the present disclosure, a master node for regrouping may be selected depending on whether there is a third-party access point (AP) in the network. Specifically, in an event that there is no third-party AP in the network, a repeater among the repeaters of the network with direct internet connection may function as the master node. Otherwise, in an event that there is a third-party AP in the network, a repeater among the repeaters of the network directly connected to the third-party AP and having a highest MAC address among the repeaters of the network that are directly connected to the third-party AP may become the master node.

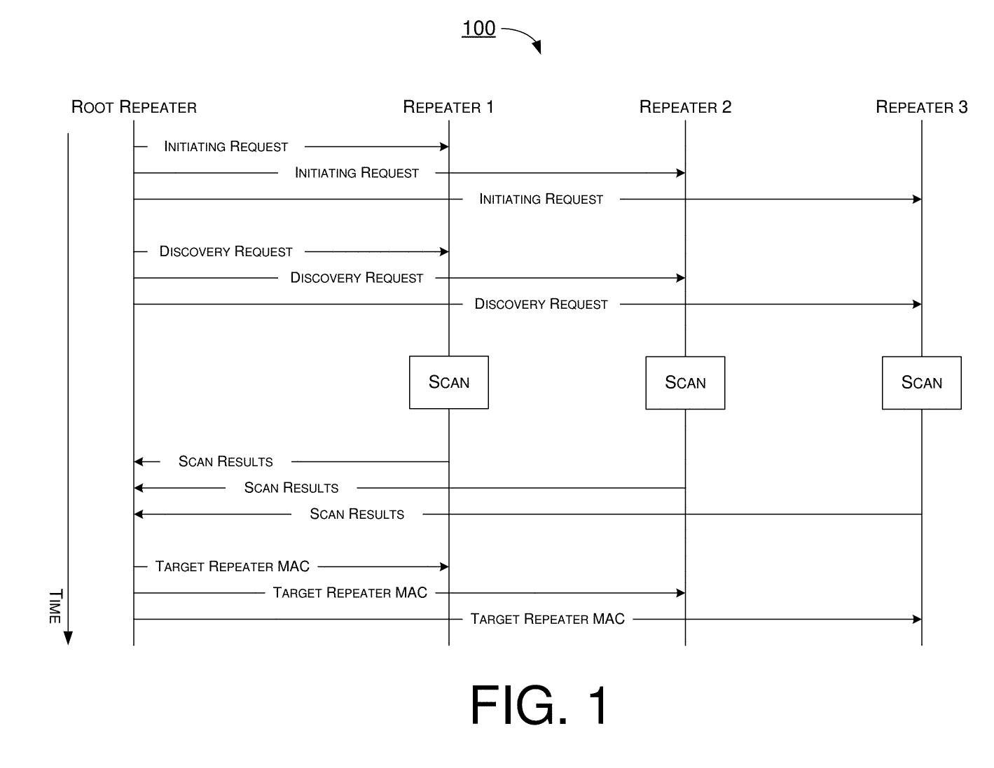

FIG. 1 illustrates an example scheme 100 of a multi-way message exchange protocol in accordance with an implementation of the present disclosure. For illustrative purposes and without limitation, a master node (denoted as “Root Repeater”) and three connected devices (denoted as “Repeater 1”, “Repeater 2” and “Repeater 3”) are shown in FIG. 1. The multi-way message exchange protocol may be utilized by the master node to initiate regrouping of the repeaters. It is noteworthy that, although a certain number of repeaters are shown in FIG. 1, in various implementations of scheme 100 the number of repeaters in the network may be different.

Under scheme 100, Root Repeater (the master node) and Repeaters 1, 2 and 3 (the three connected devices) may communicate using a four-way message exchange protocol. The Root Repeater may initiate regrouping of the three repeaters by first transmitting an initiating request to each of Repeaters 1, 2 and 3 and then transmitting an initiating request and a discovery request to each of Repeaters 1, 2 and 3. Correspondingly, each of Repeaters 1, 2 and 3 may conduct a radio frequency (RF) scan to detect signal strengths of other repeaters in the surrounding, and may transmit information on results of the scan (e.g., received signal strength indication (RSSI)) back to Root Repeater. In addition, Root Repeater itself may also conduct a RF scan to detect signal strengths of other repeaters in the surrounding. Based on the information received from Repeaters 1, 2 and 3, Root Repeater may determine how Repeaters 1, 2 and 3 are to be regrouped to form a new topology, thereby determining which repeater is to connect to which other one of Repeaters 1, 2 and 3. Thus, Root Repeater may transmit the MAC address of a respective target repeater to each of Repeaters 1, 2 and 3 so that each of Repeaters 1, 2 and 3 may connect to its respective target repeater to form the new topology.

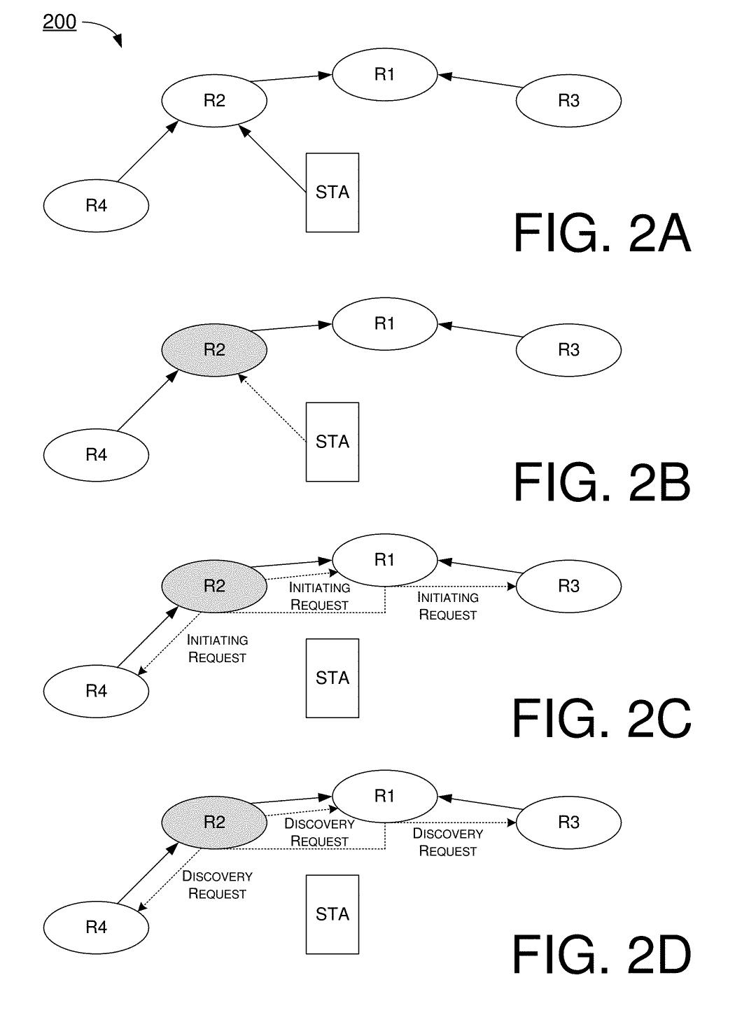

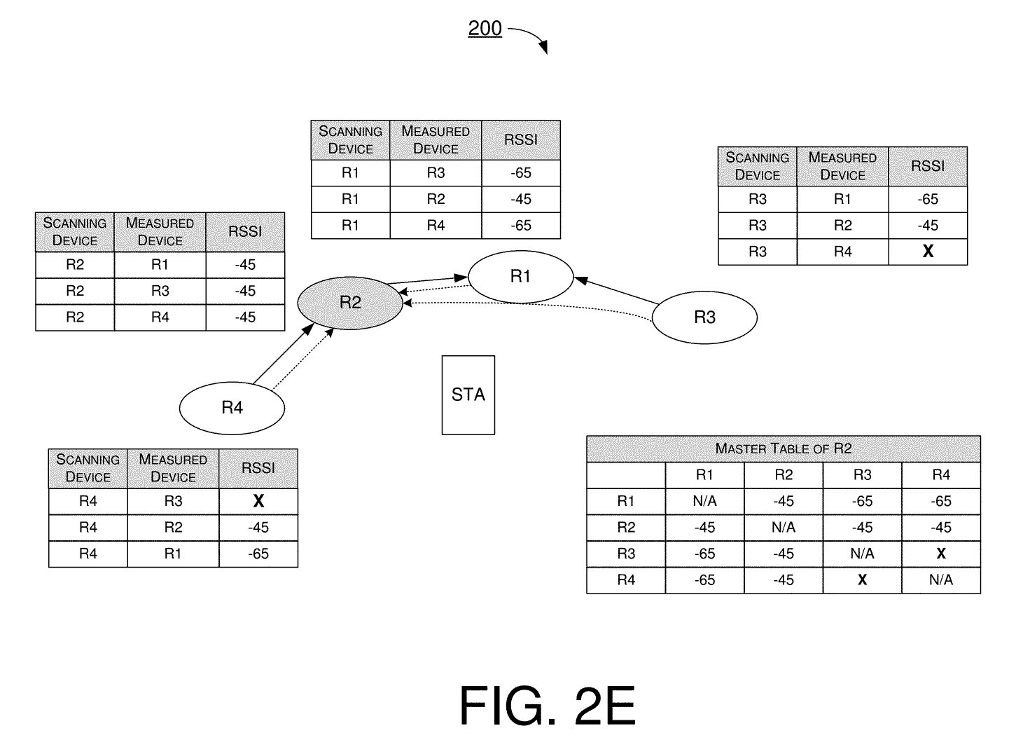

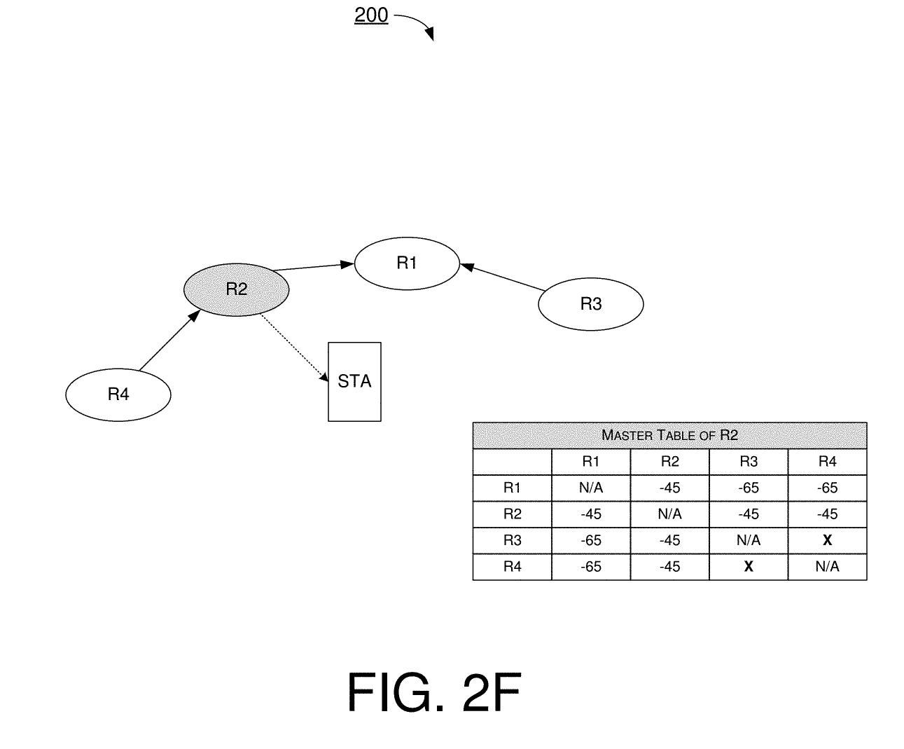

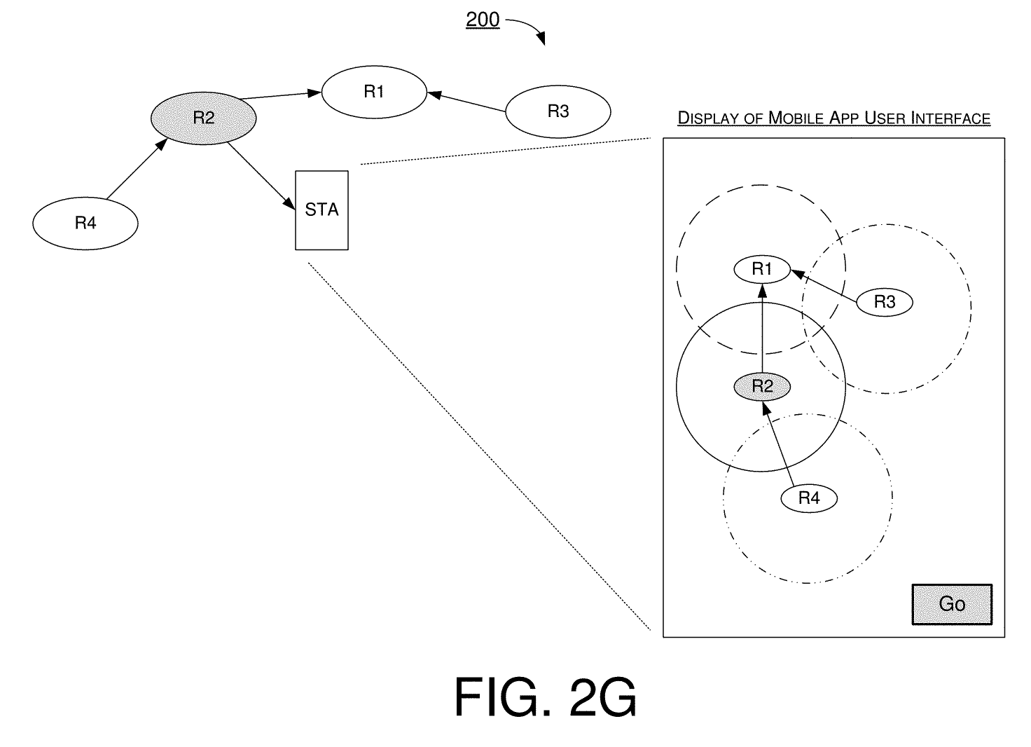

Each of FIG. 2A˜FIG. 2G illustrates a respective portion of a process under an example scheme 200 in accordance with an implementation of the present disclosure. For illustrative purposes and without limitation, a number of repeaters (denoted as “R1”, “R2”, “R3” and “R4”) and a station (denoted as “STA”) are shown in FIG. 2A˜FIG. 2G. The STA may be a user equipment such as, for example, a mobile phone, a tablet computer, a laptop computer, a wearable device or a portable device. Under scheme 200, regrouping of repeaters R1˜R4 may be triggered by a user via STA, which may connect to any of repeaters R1˜R4. The following description of scheme 200 is provided with reference to FIG. 2A˜FIG. 2G. It is noteworthy that scheme 100 for multi-way message exchange may be utilized in scheme 200 for regrouping in accordance with the present disclosure. It is also noteworthy that, although a certain number of repeaters are shown in FIG. 2A˜FIG. 2G, in various implementations of scheme 200 the number of repeaters in the network may be different.

In FIG. 2A, each of repeaters R2 and R3 is connected to repeater R1, and R4 is connected to repeater R2. Additionally, STA is also connected to repeater R2.

In FIG. 2B, regrouping of repeaters R1, R2, R3 and R4 is triggered by the user of STA via a user application (e.g., mobile app) running or otherwise executed on STA. As shown in FIG. 2B, STA notifies the triggering of regrouping to its connected repeater, which is repeater R2. Thus, repeater R2 functions as the master node/root repeater of the regrouping activity.

In FIG. 2C, repeater R2 transmits an initiating request for regrouping to each of repeaters R1, R3 and R4. Upon receiving the initiating request from repeater R2, each of repeaters R1, R3 and R4 stops scanning and would not consummate or otherwise render any new connection.

In FIG. 2D, repeater R2 transmits a discovery request to each of repeaters R1, R3 and R4. Upon receiving the discovery request from repeater R2, each of repeaters R1, R3 and R4 scans for any and all repeaters and for a root repeater in the network with which it can connect. Repeater R2 also scans for any and all repeaters in the network with which it can connect.

In FIG. 2E, each of repeaters R1, R2, R3 and R4 obtains scan results from the scanning it performed in FIG. 2D, and repeaters R1, R3 and R4 transmits information on its scan results to repeater R2. Repeater R2, as the master node/root repeater, collects the information received from repeaters R1, R3 and R4 and, together with the scan results obtained by repeater R2 itself, generates and maintains a master table of scan results by all the repeaters in the network. As shown in FIG. 2E, in an event that no signal from a particular repeater is detected during the scan, the respective RSSI for that repeater is indicated by “X”; otherwise a signal strength (e.g., −45 dB or −65 dB) is recorded and indicated accordingly.

In FIG. 2F, given that the regrouping is user-triggered by the user application on STA, repeater R2 transmits information on scan results to the user application/STA.

In FIG. 2G, based on such information, the user application displays, on a user interface of STA, a topology of the network of repeaters R1, R2, R3 and R4 with respective connection ranges of the repeaters. The size (e.g., radius) of each connection range may be proportional or otherwise representative of the RSSI of the corresponding repeater.

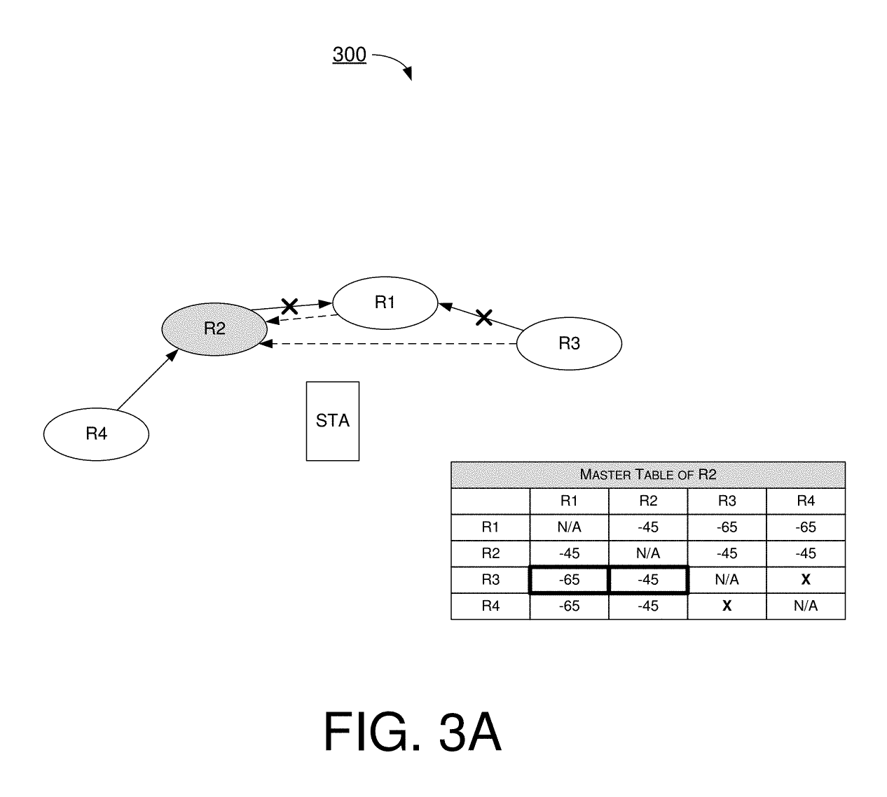

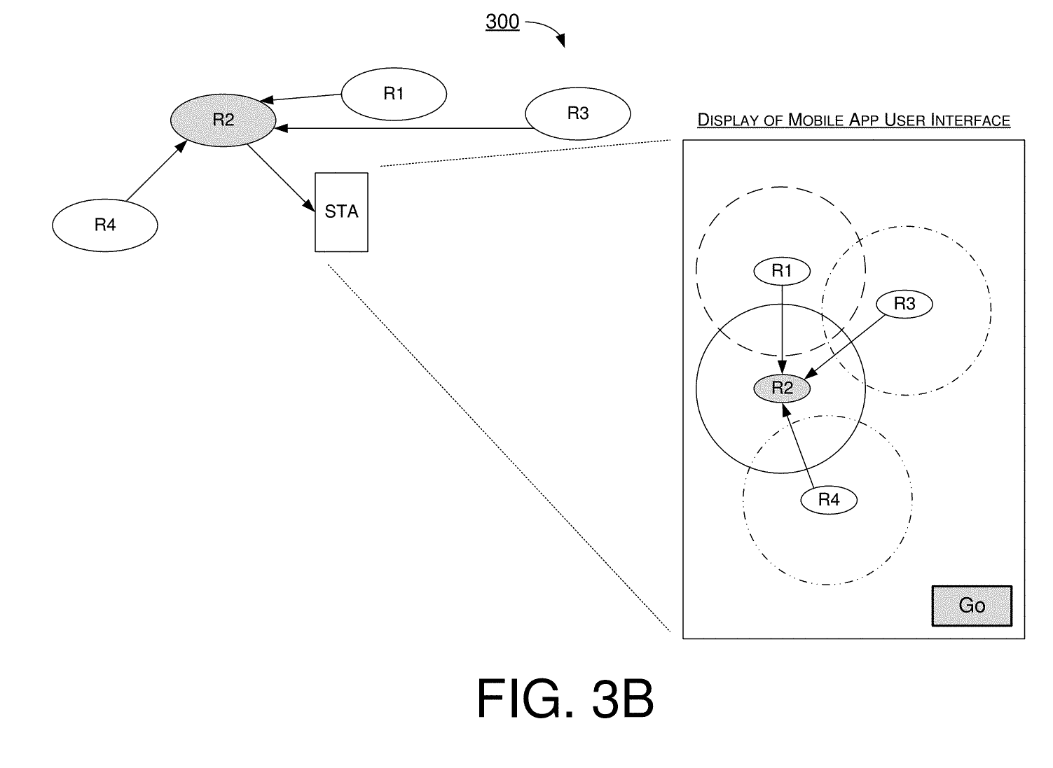

Each of FIG. 3A˜FIG. 3B illustrates a respective portion of a process under an example scheme 300 in accordance with an implementation of the present disclosure. For illustrative purposes and without limitation, a number of repeaters (denoted as “R1”, “R2”, “R3” and “R4”) and a station (denoted as “STA”) are shown in FIG. 3A˜FIG. 3B. The STA may be a user equipment such as, for example, a mobile phone, a tablet computer, a laptop computer, a wearable device or a portable device. Under scheme 300, regrouping of repeaters R1˜R4 may be triggered automatically by repeater R2, acting as the master node/root repeater of the regrouping activity. The following description of scheme 200 is provided with reference to FIG. 3A˜FIG. 3B. It is noteworthy that scheme 100 for multi-way message exchange may be utilized in scheme 300 for regrouping in accordance with the present disclosure. It is also noteworthy that, although a certain number of repeaters are shown in FIG. 3A˜FIG. 3B, in various implementations of scheme 300 the number of repeaters in the network may be different.

In FIG. 3A, as the regrouping is automatically triggered by repeater R2, repeater R2 executes an algorithm to decide optimal or best connections in the network. When execution of the algorithm is complete, for a given repeater in the network requiring reconnection due to the regrouping, a target repeater to which the given repeater is to connect is identified. Thus, repeater R2 transmits the MAC address of the respective target repeater to each repeater in the network that needs to reconnect. Otherwise, for a given repeater in the network that needs not to reconnect, no respective target repeater is identified and no MAC address is transmitted to that repeater. Alternatively, for a given repeater in the network that needs not to reconnect, a MAC address of 00:00:00:00 may be transmitted to that repeater. Upon receiving the MAC address of its target repeater, each repeater proceeds to connect to the respective target repeater. In the example shown in FIG. 3A, both of repeaters R1 and R3 are to connect to repeater R2 in the new topology. Thus, the connection from repeater R2 to repeater R1 and the connection from repeater R3 to repeater R1 are torn down or otherwise disconnected as each of repeaters R1 and R3 forms a new connection to repeater R2.

In FIG. 3B, upon completion of the regrouping activity, repeater R2 transmits information on the new topology of the network to STA. Based on such information, a user application displays, on a user interface of STA, the new topology of the network of repeaters R1, R2, R3 and R4 with respective connection ranges of the repeaters. The size (e.g., radius) of each connection range may be proportional or otherwise representative of the RSSI of the corresponding repeater.

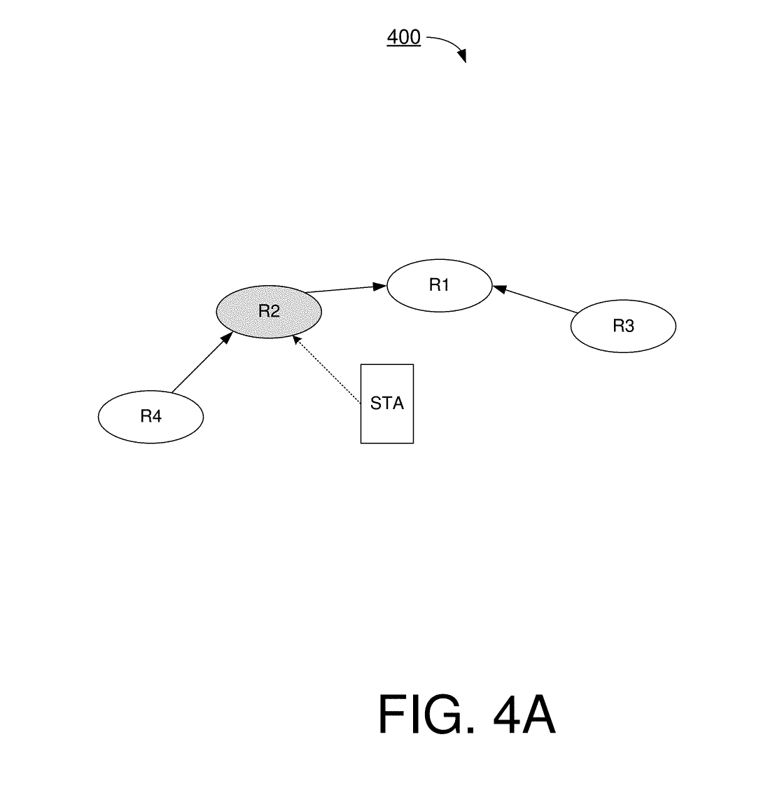

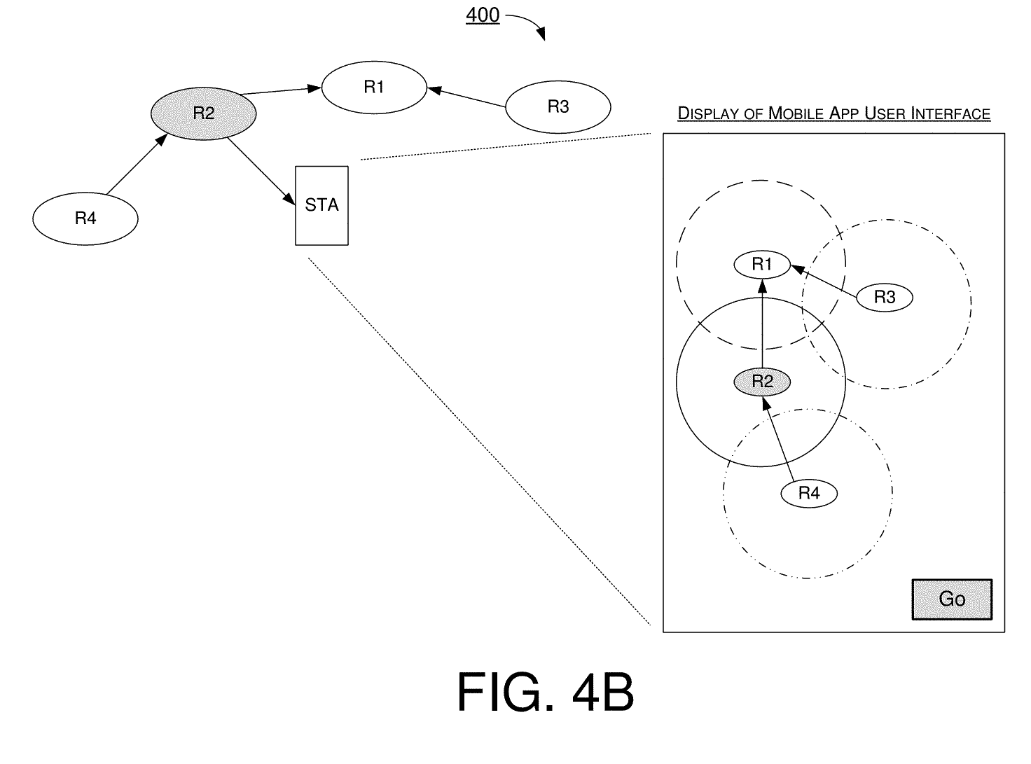

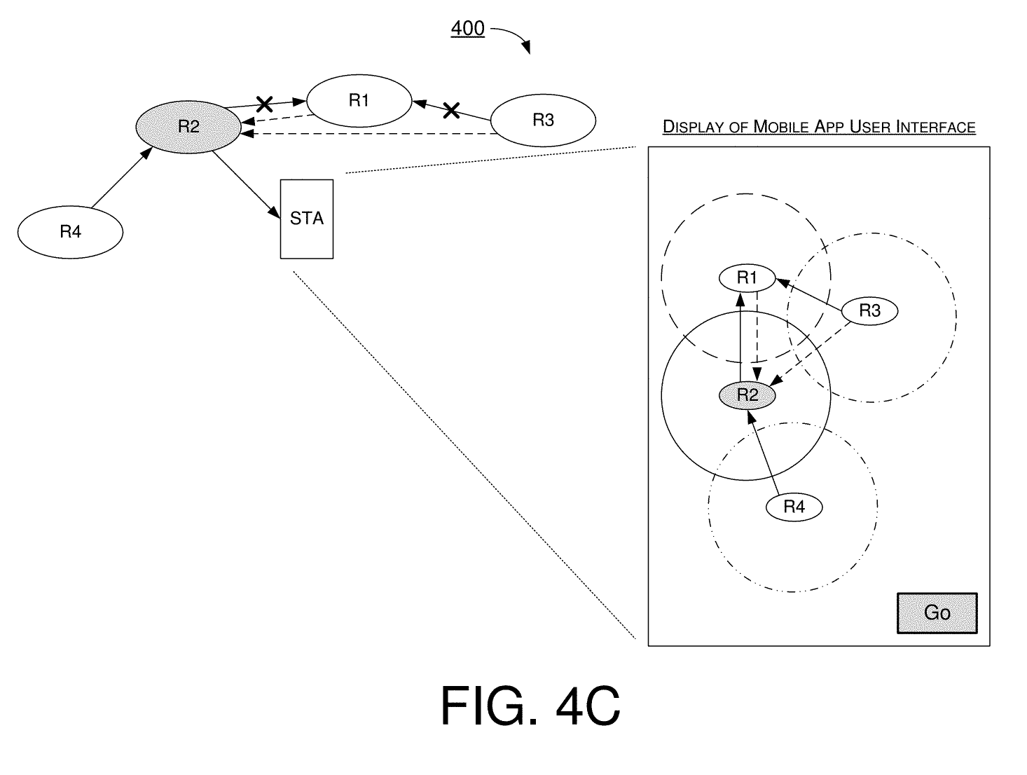

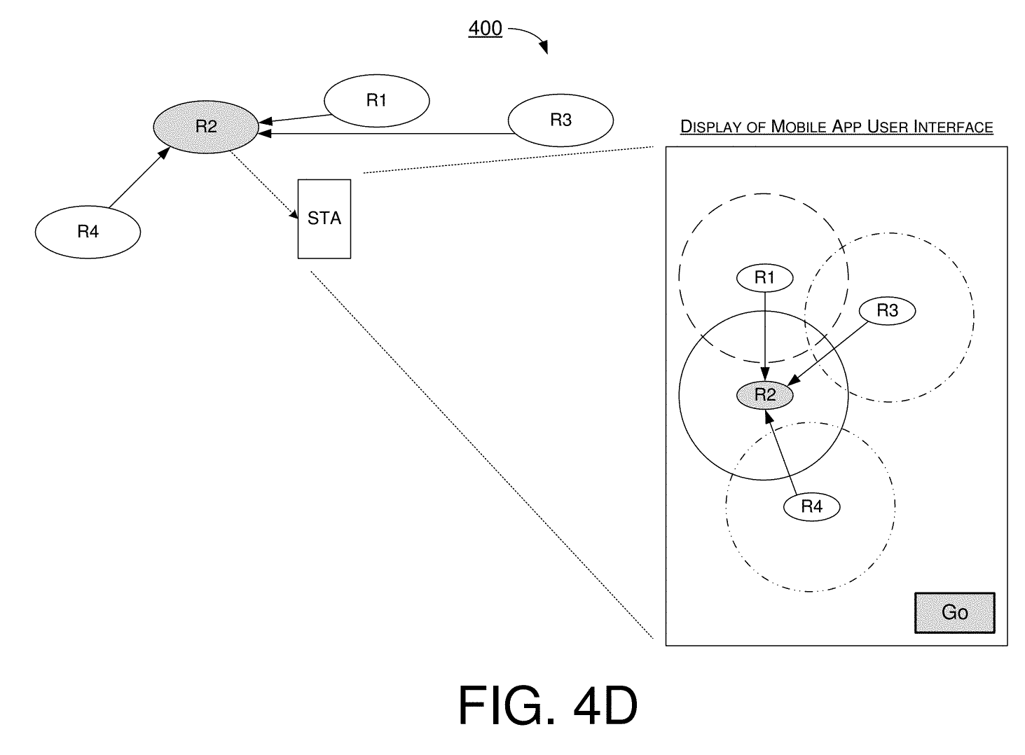

Each of FIG. 4A˜FIG. 4D illustrates a respective portion of a process under an example scheme 400 in accordance with an implementation of the present disclosure. For illustrative purposes and without limitation, a number of repeaters (denoted as “R1”, “R2”, “R3” and “R4”) and a station (denoted as “STA”) are shown in FIG. FIG. 4A˜FIG. 4D. The STA may be a user equipment such as, for example, a mobile phone, a tablet computer, a laptop computer, a wearable device or a portable device. Under scheme 400, regrouping of repeaters R1˜R4 may be triggered by an application (e.g., mobile app) running on STA. The following description of scheme 400 is provided with reference to FIG. 4A˜FIG. 4D. It is noteworthy that scheme 100 for multi-way message exchange may be utilized in scheme 400 for regrouping in accordance with the present disclosure. It is also noteworthy that, although a certain number of repeaters are shown in FIG. 4A˜FIG. 4D, in various implementations of scheme 400 the number of repeaters in the network may be different.

In FIG. 4A, each of repeaters R2 and R3 is connected to repeater R1, and repeater R4 is connected to repeater R2. Additionally, STA is also connected to repeater R2. Regrouping of repeaters R1, R2, R3 and R4 is triggered by a mobile app running or otherwise executed on STA. The STA notifies the triggering of regrouping to its connected repeater, which is repeater R2. Thus, repeater R2 functions as the master node/root repeater of the regrouping activity.

In FIG. 4B, upon receiving the notification from STA about regrouping, repeater R2 transmits information on the current topology of the network to STA. Based on such information, the mobile app displays, on a user interface of STA, the current topology of the network of repeaters R1, R2, R3 and R4 with respective connection ranges of the repeaters. The size (e.g., radius) of each connection range may be proportional or otherwise representative of the RSSI of the corresponding repeater.

In FIG. 4C, the mobile app changes the current topology to a star topology. Specifically, in the new topology which is a star topology, each of repeaters R1 and R3 is connected to repeater R2, and repeater R4 is still connected to repeater R2. Moreover, since repeaters R1 and R4 are not in connection range of each other, the mobile app does not allow connection between repeaters R1 and R4. Similarly, since repeaters R3 and R4 are not in connection range of each other, the mobile app does not allow connection between repeaters R3 and R4. In the example shown in FIG. 4C, both of repeaters R1 and R3 are to connect to repeater R2 in the new topology. Thus, the connection from repeater R2 to repeater R1 and the connection from repeater R3 to repeater R1 are torn down or otherwise disconnected as each of repeaters R1 and R3 forms a new connection to repeater R2.

In FIG. 4D, upon completion of the regrouping activity, repeater R2 transmits information on the new topology (star topology) of the network to STA. Based on such information, the mobile app displays, on a user interface of STA, the new topology of the network of repeaters R1, R2, R3 and R4 with respective connection ranges of the repeaters. The size (e.g., radius) of each connection range may be proportional or otherwise representative of the RSSI of the corresponding repeater.

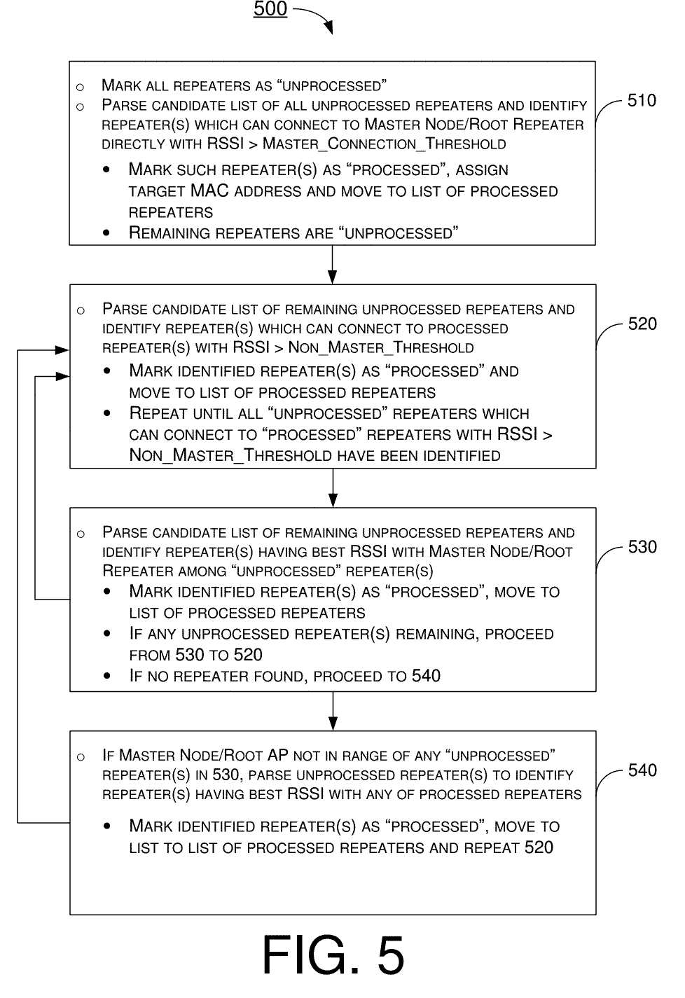

FIG. 5 illustrates an example logic flow 500 in accordance with an implementation of the present disclosure. Logic flow 500 may be an example implementation of an algorithm utilized by a master node/root repeater for regrouping in accordance with the present disclosure. Logic flow 500 may involve one or more operations, actions, or functions as illustrated by one or more of blocks 510, 520, 530 and 540. Although illustrated as discrete blocks, various blocks of logic flow 500 may be divided into additional blocks, combined into fewer blocks, or eliminated, depending on the desired implementation. Moreover, the blocks/sub-blocks of logic flow 500 may executed in the order shown in FIG. 5 or, alternatively in a different order. Logic flow 500 may be implemented in and by the master node/root repeater in schemes 100, 200, 300 and 400 described above, as well as scenarios 600, 700 and 800 described below. Logic flow 500 may begin at block 510.

At 510 (herein interchangeably referred as “Step 1”), logic flow 500 may involve the master node/root repeater initially marking all repeaters in a network as “unprocessed.” Logic flow 500 may then involve master node/root repeater parsing candidate list(s) of all “unprocessed” repeaters and identifying repeater(s) which can connect to the master node/root repeater with ideal RSSI that is greater than a master connection threshold (e.g., RSSI>Master_Connection_Threshold). Each of the identified repeater(s) may be marked as “processed” and moved to a list of “processed” repeaters, with the rest of the repeater(s) in the network remaining “unprocessed.” Moreover, each of the identified repeater(s) may be assigned a target MAC address of a target repeater to which the identified repeater is to connect. At Step 1, as the master node/root repeater may be the target repeater, each of the identified repeater(s) may be connected to the master node/root repeater. Logic flow 500 may proceed from 510 to 520.

At 520 (herein interchangeably referred as “Step 2”), logic flow 500 may involve the master node/root repeater parsing the candidate list(s) of remaining “unprocessed” repeaters and identifying repeater(s) which can connect to any of the “processed” repeater(s) with ideal RSSI that is greater than a non-master connection threshold (e.g., RSSI>Non_Master_Threshold). Each of the identified repeater(s) may be marked as “processed” and moved to the list of “processed” repeaters, with the rest of the repeater(s) in the network remaining “unprocessed.” Logic flow 500 may repeat 520 one or more times until all “unprocessed” repeaters which can connect to one of the “processed” repeaters with ideal RSSI (e.g., RSSI>Non_Master_Threshold) have been identified, and at that point logic flow 500 may proceed from 520 to 530.

At 530 (herein interchangeably referred as “Step 3”), logic flow 500 may involve the master node/root repeater parsing the candidate list(s) of remaining “unprocessed” repeaters (which could not connect to the master node/root repeater or any of the “processed” repeaters due to RSSI being lower than the two thresholds) and identifying at least one “unprocessed” repeater having the best RSSI with the master node/root repeater amongst remaining “unprocessed” repeater(s). The identified repeater may be marked as “processed” and moved to the list of “processed” repeaters. If there is any “unprocessed” repeater remaining, logic flow 500 may proceed from 530 to 520. On the other hand, if there is no repeater identified or otherwise found by the operations of 530 (e.g., no repeater in range with the root repeater and no repeater could be marked as “processed”), logic flow 500 may proceed from 530 to 540.

At 540 (herein interchangeably referred as “Step 4”), if there is any “unprocessed” repeater not in range of the master node/root repeater, logic flow 500 may involve the master node/root repeater parsing the candidate list(s) of remaining “unprocessed” repeaters and identifying at least one “unprocessed” repeater having the best RSSI with one of the “processed” repeaters amongst remaining “unprocessed” repeater(s). The identified repeater may be marked as “processed” and moved to the list of “processed” repeaters. Logic flow 500 may then proceed from 540 to 520.

It is noteworthy that logic flow 500 may optimize the connections between repeaters based on number of hops and RSSI. That is, in determining which repeater is to connect to which other repeater, logic flow 500 may favor fewer hops over more hops between the master node/root repeater and any given repeater in the network, and logic flow 500 may choose a connection with a strong signal strength over another connection with a weak signal strength. Additionally, it is noteworthy that logic flow 500 is merely an illustrative example, the regrouping mechanism in accordance with the present disclosure is not limited to logic flow 500 as described herein and shown in FIG. 5. For instance, a number of parameters may be added to the algorithm/logic flow to make the connections between repeaters even more optimized and robust.

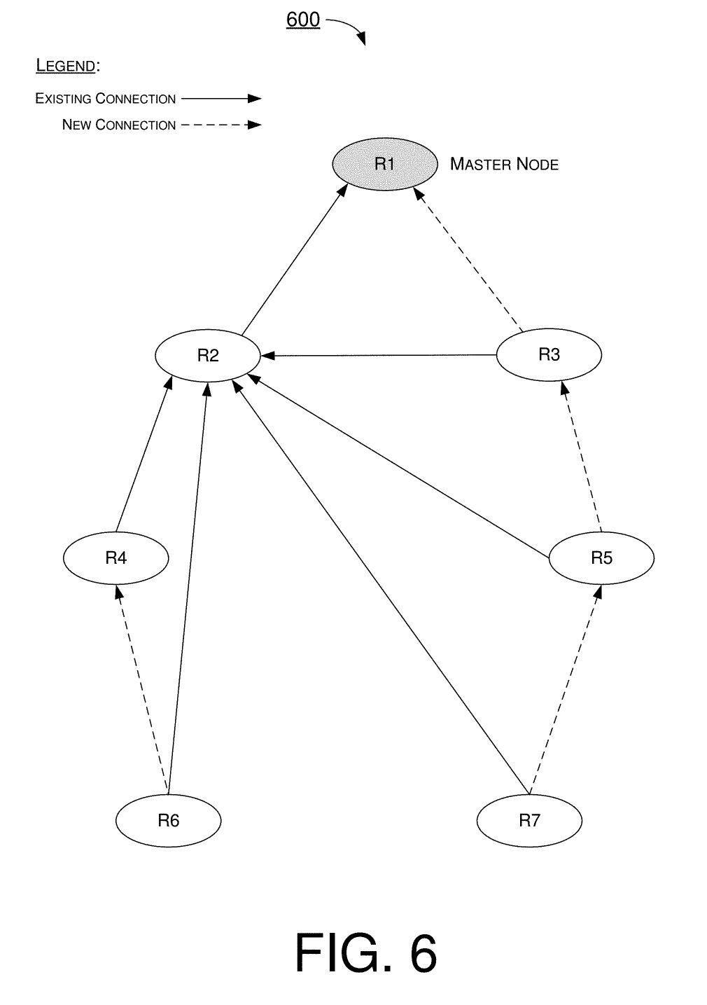

FIG. 6 illustrates an example scenario 600 in accordance with an implementation of the present disclosure. Scenario 600 may be an illustrative example of execution of Step 1 and Step 2 of logic flow 500. Referring to FIG. 6, scenario 600 involves repeaters R1, R2, R3, R4, R5, R6 and R7, with repeater R1 being the master node. Initially, repeater R2 is connected to master node R1, and each of repeaters R3, R4, R5, R6 and R7 is connected to repeater R2. Conditions of scenario 600 include that there is ideal RSSI between each of repeaters R2 and R3 and master node R1 (e.g., RSSI>Master_Connection_Threshold). Additionally, there is less-than-ideal RSSI between each of repeaters R4, R5, R6 and R7 and master node R1 (e.g., RSSI<Master_Connection_Threshold). It is noteworthy that scheme 100 for multi-way message exchange may be utilized in scenario 600 for regrouping in accordance with the present disclosure.

Under scenario 600, by executing Step 1 of logic flow 500, repeater R3 may be directly connected to master node R1 instead of being connected to repeater R2. By executing Step 2 of logic flow 500, each of repeaters R4 and R5 may be connected to either repeater R2 or repeater R3 since there is ideal RSSI between each of repeaters R4 and R5 and repeaters R2 and R3 (e.g., RSSI>Non_Master_Threshold). In the example shown in FIG. 6, repeater R4 may remain connected to repeater R2, as there may be better RSSI between repeaters R4 and R2 than that between repeaters R4 and R3. Moreover, repeater R5 may be connected to repeater R3, as there may be better RSSI between repeaters R5 and R3 than that between repeaters R5 and R2. Similarly, repeater R6 may be connected to repeater R4 instead of repeater R2, as the RSSI between repeaters R6 and R2 may be less than Non_Master_Threshold. Moreover, repeater R7 may be connected to repeater R5, as there may be better RSSI between repeaters R7 and R5 than that between repeaters R7 and R2. This may be explained in an iterative way. For instance, in a first iteration of Step 2, R2 may connect to R3 and R6 may connect to R4. In a second iteration of Step 2, since R5 has also become processed, now R7 may connect to R5. R7 may not connect to R2 or R3 since RSSI is less than Non_Master_Threshold.

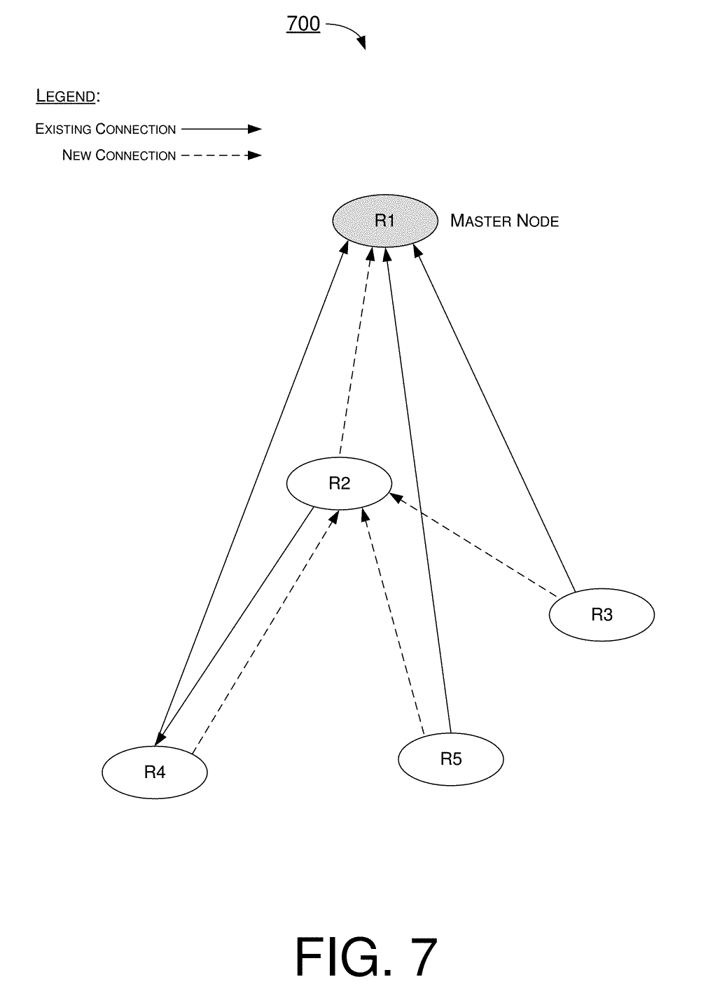

FIG. 7 illustrates an example scenario 700 in accordance with an implementation of the present disclosure. Scenario 700 may be an illustrative example of execution of Step 3 of logic flow 500. Referring to FIG. 7, scenario 700 involves repeaters R1, R2, R3, R4 and R5, with repeater R1 being the master node. Initially, each of repeaters R3, R4 and R5 is connected to master node R1, with repeater R2 connected to repeater R3. Conditions of scenario 700 include that RSSI is not ideal between repeater R2 and master node R1. Here, repeater R2 is connected to master node R1 because, according to Step 3, the RSSI between repeater R2 and master node R1 is the best among the following RSSI strengths: the RSSI between repeater R2 and master node R1, the RSSI between repeater R3 and master node R1, the RSSI between repeater 4 and master node R1, and the RSSI between repeater R5 and master node R1. That is, there is less-than-ideal RSSI between each of repeaters R3, R4 and R5 and master node R1 (e.g., RSSI<Master_Connection_Threshold). Moreover, there is ideal RSSI between repeater R2 and each of repeaters R3, R4 and R5 (e.g., RSSI>Non_Master_Threshold). It is noteworthy that scheme 100 for multi-way message exchange may be utilized in scenario 700 for regrouping in accordance with the present disclosure.

Under scenario 700, by executing Step 3 of logic flow 500, repeater R2 may be directly connected to master node R1 instead of being connected to repeater R3, since the RSSI between repeater R2 and master node R1 may be better than that among repeaters R2, R3, R4 and R5. Moreover, each of repeaters R3, R4 and R5 may be connected to repeater R2 instead of being connected to master node R1, since there may be ideal RSSI between repeater R2 and each of repeaters R3, R4 and R5 (e.g., RSSI>Non_Master_Threshold).

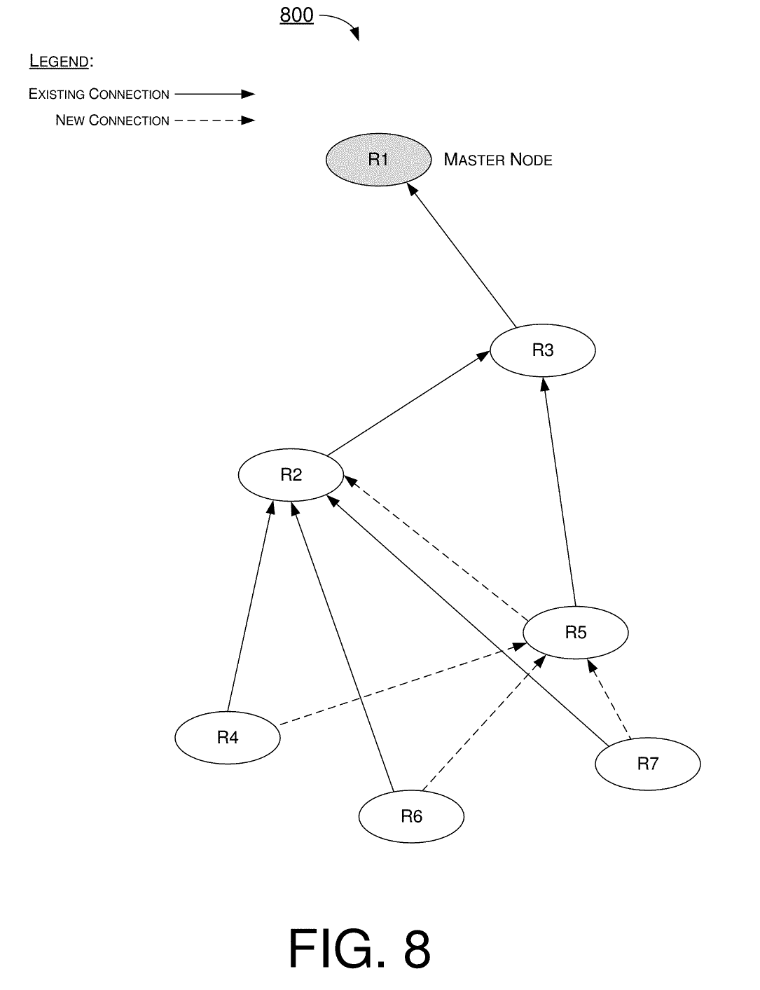

FIG. 8 illustrates an example scenario 800 in accordance with an implementation of the present disclosure. Scenario 800 may be an illustrative example of execution of Step 4 of logic flow 500. Referring to FIG. 8, scenario 800 involves repeaters R1, R2, R3, R4, R5, R6 and R7, with repeater R1 being the master node. Initially, repeater R3 is connected to master node R1, each of repeaters R2 and R5 is connected to repeater R3, and each of repeaters R4, R6 and R7 is connected to repeater R2. Conditions of scenario 800 include that there is less-than-ideal RSSI between repeater R5 and master node R1 (e.g., RSSI<Master_Connection_Threshold) and between repeater R5 and repeater R3 (e.g., RSSI<Non_Master_Threshold). Additionally, repeater R5 is not in range of master node R1. Moreover, the RSSI between repeater R4 and repeater R2, the RSSI between repeater R6 and repeater R2, and the RSSI between repeater R7 and repeater R2 are also not ideal and that each of repeaters R4, R6 and R7 is not in range of master node R1. It is noteworthy that scheme 100 for multi-way message exchange may be utilized in scenario 800 for regrouping in accordance with the present disclosure.

Under scenario 800, by executing Step 4 of logic flow 500, repeater R5 may scan and determine its RSSI with each of the non-master node repeaters R2, R3, R4, R6 and R7. That is, in an event that master node is not visible, then all the unprocessed repeaters may be checked for RSSI with processed repeaters, and one of the unprocessed repeaters whose RSSI with the processed repeaters is the best among the unprocessed repeaters may be selected. In the example shown in FIG. 8, based on the scan results, repeater R5 may determine that the RSSI between repeaters R2 and R5 may be better or greater than the RSSI between repeaters R5 and R3, and thus R5 may change its connection from being connected to repeater R3 to being connected to repeater R2. Moreover, the RSSI between repeaters R4 and R5, the RSSI between repeaters R6 and R5, and the RSSI between repeaters R7 and R5 may be greater than the non-master threshold (e.g., RSSI>Non_Master_Threshold). Thus, each of repeaters R4, R6 and R7 may be connected to repeater R5 instead of repeater R2.

### Illustrative Implementations

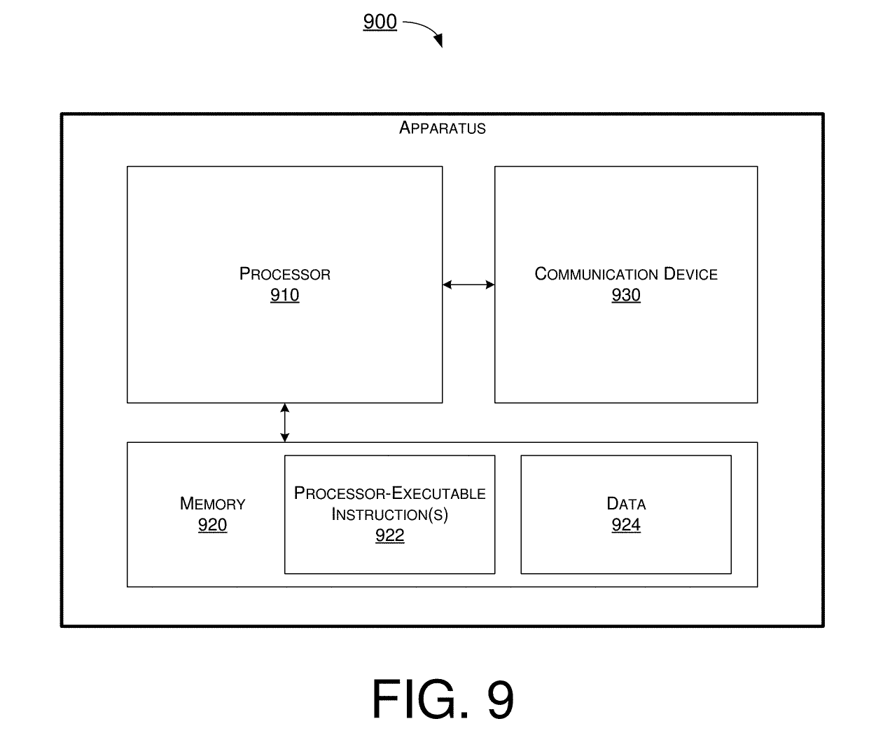

FIG. 9 illustrates an example apparatus 900 in accordance with an implementation of the present disclosure. Apparatus 900 may perform various functions to implement schemes, techniques, processes and methods described herein pertaining to loop avoidance in repeater networks, including schemes 100, 200, 300 and 400, logic flow 500, and scenarios 600, 700 and 800 described above, as well as processes 1000 and 1100 described below. Apparatus 900 may be a part of an electronic apparatus which may be a communication device, a computing apparatus, a portable or mobile apparatus, or a wearable apparatus. For instance, apparatus 900 may be implemented in a repeater as a master node/root repeater, a Wi-Fi access point, a smartphone, a smartwatch, a smart bracelet, a smart necklace, a personal digital assistant, or a computing device such as a tablet computer, a laptop computer, a notebook computer, a desktop computer, or a server. Alternatively, apparatus 900 may be implemented in the form of one or more integrated-circuit (IC) chips such as, for example and not limited to, one or more single-core processors, one or more multi-core processors, or one or more complex-instruction-set-computing (CISC) processors. Apparatus 900 may include at least those components shown in FIG. 9, such as a processor 910 and a memory 920. Additionally, apparatus 900 may include a communication device 930 which may be a transceiver. Communication device 930 may be configured to transmit and receive data wirelessly (e.g., in compliance with the IEEE 902.11 specification and/or any applicable wireless protocols and standards).

Memory 920 may be a storage device configured to store one or more sets of codes, programs and/or instructions 922 as well as data 924 therein. For example, memory 920 may be operatively coupled to processor 910 to receive data 924 (e.g., results of scan). When apparatus 900 is implemented in or as a first communication device such as a first repeater, memory 920 may store a respective first node number of the first communication device. Memory 920 may be implemented by any suitable technology and may include volatile memory and/or non-volatile memory. For example, memory 920 may include a type of random-access memory (RAM) such as dynamic RAM (DRAM), static RAM (SRAM), thyristor RAM (T-RAM) and/or zero-capacitor RAM (Z-RAM). Alternatively or additionally, memory 920 may include a type of read-only memory (ROM) such as mask ROM, programmable ROM (PROM), erasable programmable ROM (EPROM) and/or electrically erasable programmable ROM (EEPROM). Alternatively or additionally, memory 920 may include a type of non-volatile random-access memory (NVRAM) such as flash memory, solid-state memory, ferroelectric RAM (FeRAM), magnetoresistive RAM (MRAM) and/or phase-change memory.

Processor 910 may be implemented in the form of one or more single-core processors, one or more multi-core processors, or one or more CISC processors. That is, processor 910 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure, including forming an optimized repeater network.

Processor 910 may access memory 920 to execute the one or more instructions stored in memory 920. Upon executing the one or more sets of instructions, processor 910 may be configured to perform operations pertaining to forming an optimized repeater network in accordance with the present disclosure. For instance, processor 910 may be in communications, via communication device 930, with a plurality of repeaters in a network of a first topology. Processor 910 may regroup the plurality of repeaters to form a network of a second topology different from the first topology.

In some implementations, in regrouping the plurality of repeaters, processor 910 may perform a number of operations. For instance, processor 910 may transmit, via communication device 930, an initiating request and a discovery request to the plurality of repeaters to cause each repeater of the plurality of repeaters to conduct a scan to detect signal strengths of other repeaters of the plurality of repeaters. Processor 910 may receive, via communication device 930, information on results of the scan from each repeater of the plurality of repeaters (e.g., RSSI between the respective repeater and each of one or more other repeaters of the plurality of repeaters). Processor 910 may direct, via communication device 930, the plurality of repeaters to form the network of the second topology based on the received information.

In some implementations, in directing the plurality of repeaters to form the network of the second topology, processor 910 may, for a respective repeater of the plurality of repeaters, identify a target repeater among the plurality of repeaters to which the respective repeater is to connect. Moreover, for the respective repeater, processor 910 may transmit, via communication device 930, an address of the target repeater to the respective repeater such that, upon receiving the address of the target repeater, the respective repeater establishes a connection to the target repeater. In some implementations, in identifying the target repeater, processor 910 may select the target repeater among the plurality of repeaters based on a signal strength between the target repeater and the respective repeater, a number of hops between the respective repeater and the master node in the second topology, or both.

In some implementations, processor 910 may be capable of regrouping the plurality of repeaters as a result of: (1) automatic triggering of the regrouping by processor 910, (2) receiving, via communication device 930, a signal from an application executed on a client device that is communicatively connected to the processor such that the signal causes the processor to trigger the regrouping, or (3) receiving, via communication device 930, a user command from a user of the client device that instructs the processor to regroup the plurality of repeaters to form the network in the second topology.

In some implementations, processor 910 may be further capable of performing a number of operations. For instance, processor 910 may transmit, to the client device via communication device 930 prior to directing the plurality of repeaters to form the network of the second topology, topology information of the first topology which is displayable on the client device. Moreover, processor 910 may transmit, to the client device via communication device 930 after directing the plurality of repeaters to form the network of the second topology, topology information of the second topology which is displayable on the client device. In such cases, the regrouping of the plurality of repeaters may be triggered by receiving the signal from the application executed on the client device or receiving the user command from the user of the client device.

In some implementations, in regrouping the plurality of repeaters, processor 910 may be capable of performing a number of operations. For instance, processor 910 may set a status of each of the plurality of repeaters to indicate an unprocessed state. Additionally, processor 910 may parse a list of the plurality of repeaters to identify one or more first repeaters of the plurality of repeaters such that a respective signal strength between each of the one or more first repeaters and a master node is greater than a first threshold. Moreover, processor 910 may set the status of each of the one or more first repeaters to indicate a processed state. Furthermore, processor 910 may transmit, via communication device 930, an address of a target repeater to each of the one or more first repeaters such that each of the one or more first repeaters is connected to the target repeater.

In some implementations, in regrouping the plurality of repeaters, processor 910 may be further capable of performing additional operations. For instance, processor 910 may parse a remainder of the list of the plurality of repeaters each of which having a status indicating the unprocessed state to identify one or more second repeaters of the plurality of repeaters such that a respective signal strength between each of the one or more second repeaters and a respective one of the one or more first repeaters is greater than a second threshold different from the first threshold. Processor 910 may also set the status of each of the one or more second repeaters to indicate the processed state. For each of the one or more second repeaters, processor 910 may transmit, via communication device 930, an address of the respective one of the one or more first repeaters such that each of the one or more second repeaters is connected to the respective one of the one or more first repeaters.

In some implementations, in regrouping the plurality of repeaters, processor 910 may be further capable of performing additional operations. For instance, processor 910 may parse a remainder of the list of the plurality of repeaters each of which having a status indicating the unprocessed state to identify at least a third repeater of the plurality of repeaters such that a respective signal strength between the third repeater and the master node is greater than a respective signal strength between the master node and each of a remainder of the list of the plurality of repeaters each of which having the status indicating the unprocessed state. Processor 910 may also set the status of the third repeater to indicate the processed state. Processor 910 may transmit, via communication device 930, an address of a respective one of the one or more first repeaters or a respective one of the one or more second repeaters to the third repeater such that the third repeater is connected to the respective one of the one or more first repeaters, the respective one of the one or more second repeaters or the master node. If such a repeater is identified, Step 2 of logic flow 500 may be repeated to identify whether any unprocessed repeater can directly connect to this new processed repeater.

In some implementations, in regrouping the plurality of repeaters, processor 910 may be further capable of performing additional operations. For instance, processor 910 may parse a remainder of the list of the plurality of repeaters each of which having a status indicating the unprocessed state to identify at least a fourth repeater of the plurality of repeaters such that a respective signal strength between the fourth repeater and the master node is greater than a respective signal strength between the master node and each of a remainder of the list of the plurality of repeaters each of which having the status indicating the unprocessed state. It is noteworthy that Step 4 of logic flow 500 is for those repeaters to which master node is not visible. In this case, RSSI of all unprocessed repeaters may be checked with all the processed repeaters, and one unprocessed repeater may be identified as having the best RSSI with the processed repeaters. This identified unprocessed repeater may be marked as processed and Step 2 of logic flow 500 may be executed again. Processor 910 may set the status of the fourth repeater to indicate the processed state. Processor 910 may transmit, via communication device 930, an address of a respective one of the one or more first repeaters, a respective one of the one or more second repeaters, or the third repeater to the fourth repeater such that the fourth repeater is connected to the respective one of the one or more first repeaters, the respective one of the one or more second repeaters, or the third repeater.

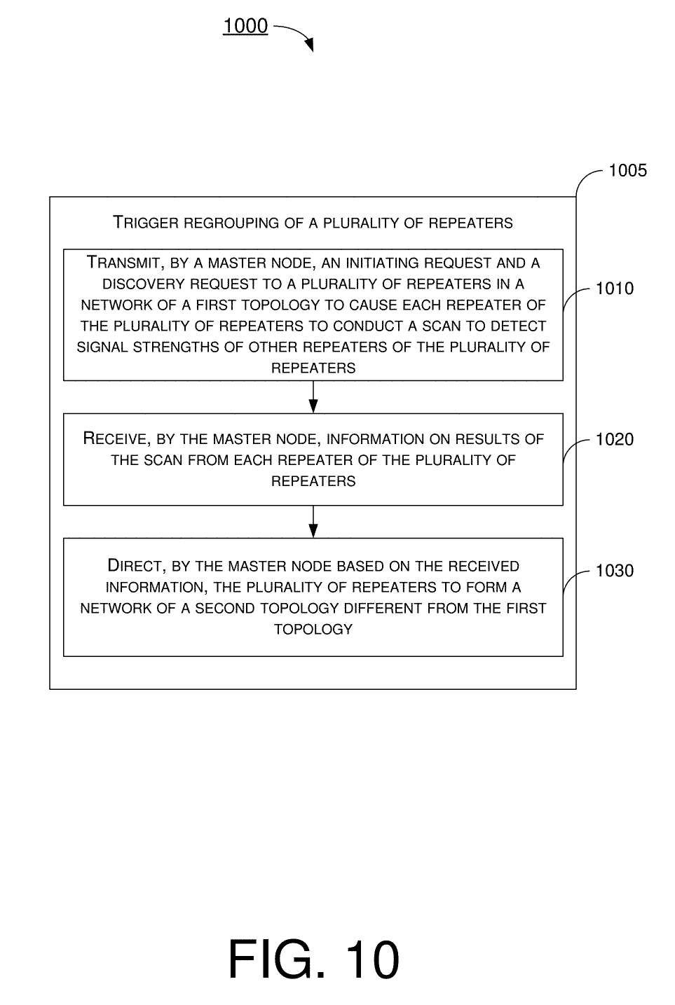

FIG. 10 illustrates an example process 1000 in accordance with an implementation of the present disclosure. Process 1000 may represent an aspect of implementing features of apparatus 900. Process 1000 may include one or more operations, actions, or functions as illustrated by block 1005 and sub-blocks 1010, 1020 and 1030. Although illustrated as discrete blocks, various blocks of process 1000 may be divided into additional blocks, combined into fewer blocks, or eliminated, depending on the desired implementation. Moreover, the blocks/sub-blocks of process 1000 may executed in the order shown in FIG. 10 or, alternatively in a different order. Process 1000 may be implemented by apparatus 900 and any variations thereof. For instance, process 1000 may be implemented in and by the master node/root repeater in schemes 100, 200, 300 and 400, logic flow 500, and scenarios 600, 700 and 800 described above. Solely for illustrative purposes, process 1000 is described below in the context of apparatus 900 being a master node/root repeater in a network of a plurality of repeaters. Process 1000 may begin at block 1005.

At 1005, process 1000 may involve processor 910 of apparatus 900 triggering regrouping of the plurality of repeaters. In particular, the triggering the regrouping of the plurality of repeaters may be represented by sub-blocks 1010, 1020 and 1030.

At 1010, process 1000 may involve processor 910 transmitting, via communication device 930, an initiating request and a discovery request to each repeater of the plurality of repeaters in a network of a first topology to cause each repeater of the plurality of repeaters to conduct a scan to detect signal strengths of other repeaters of the plurality of repeaters. Process 1000 may proceed from 1010 to 1020.

At 1020, process 1000 may involve processor 910 receiving, via communication device 930, information on results of the scan from each repeater of the plurality of repeaters. Process 1000 may proceed from 1020 to 1030.

At 1030, process 1000 may involve processor 910 directing, based on the received information, the plurality of repeaters to form a network of a second topology different from the first topology.

In some implementations, in receiving the information on the results of the scan from each repeater of the plurality of repeaters, process 1000 may involve processor 910 receiving from each repeater, via communication device 930, information on RSSI between the respective repeater and each of one or more other repeaters of the plurality of repeaters.

In some implementations, in directing the plurality of repeaters to form the network of the second topology, process 1000 may involve processor 910 performing, for a respective repeater of the plurality of repeaters, a number of operations. For instance, process 1000 may involve processor 910 identifying a target repeater among the plurality of repeaters to which the respective repeater is to connect. Additionally, process 1000 may involve processor 910 transmitting, via communication device 930, an address of the target repeater to the respective repeater such that, upon receiving the address of the target repeater, the respective repeater establishes a connection to the target repeater.

In some implementations, in identifying the target repeater, process 1000 may involve processor 910 selecting the target repeater among the plurality of repeaters based on a signal strength between the target repeater and the respective repeater, a number of hops between the respective repeater and the master node in the second topology, or both.

In some implementations, the triggering of the regrouping of the plurality of repeaters may be a result of one of: (1) automatically triggering the regrouping by the master node, (2) receiving, by processor 910 via communication device 930, a signal from an application executed on a client device that is communicatively connected to the master node such that the signal causes the master node to trigger the regrouping, or (3) receiving, by processor 910 via communication device 930, a user command from a user of the client device that instructs the master node to regroup the plurality of repeaters to form the network in the second topology.

In some implementations, process 1000 may involve processor 910 performing additional operations. For instance, process 1000 may involve processor 910 transmitting, to the client device via communication device 930 prior to directing the plurality of repeaters to form the network of the second topology, topology information of the first topology which is displayable on the client device. Moreover, process 1000 may involve processor 910 transmitting, to the client device via communication device 930 after directing the plurality of repeaters to form the network of the second topology, topology information of the second topology which is displayable on the client device. In such cases, the triggering of the regrouping of the plurality of repeaters may be a result of receiving the signal from the application executed on the client device or receiving the user command from the user of the client device.

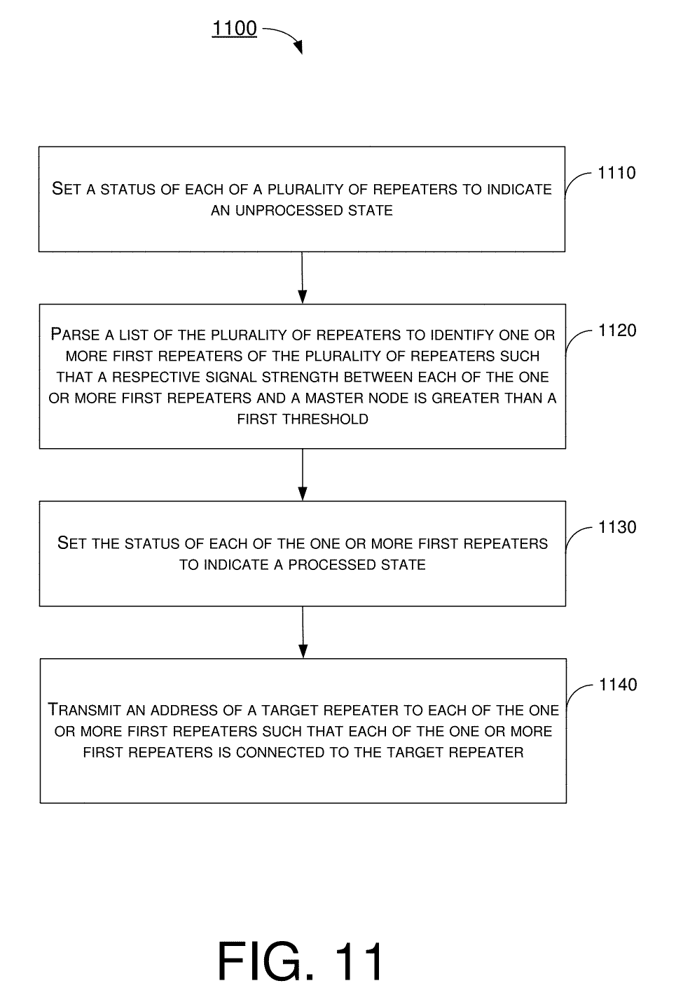

FIG. 11 illustrates an example process 1100 in accordance with an implementation of the present disclosure. Process 1100 may represent an aspect of implementing features of apparatus 900. Process 1100 may include one or more operations, actions, or functions as illustrated by blocks 1110, 1120, 1130 and 1140. Although illustrated as discrete blocks, various blocks of process 1100 may be divided into additional blocks, combined into fewer blocks, or eliminated, depending on the desired implementation. Moreover, the blocks/sub-blocks of process 1100 may executed in the order shown in FIG. 11 or, alternatively in a different order. Process 1100 may be implemented by apparatus 900 and any variations thereof. For instance, process 1100 may be implemented in and by the master node/root repeater in schemes 110, 200, 300 and 400, logic flow 500, and scenarios 600, 700 and 800 described above. Solely for illustrative purposes, process 1100 is described below in the context of apparatus 900 being a master node/root repeater in a network of a plurality of repeaters. Process 1100 may begin at block 1110.

At 1110, process 1100 may involve processor 910 setting a status of each of a plurality of repeaters to indicate an unprocessed state. Process 1100 may proceed from 1110 to 1120.

At 1120, process 1100 may involve processor 910 parsing a list of the plurality of repeaters to identify one or more first repeaters of the plurality of repeaters such that a respective signal strength between each of the one or more first repeaters and a master node is greater than a first threshold. Process 1100 may proceed from 1120 to 1130.

At 1130, process 1100 may involve processor 910 setting the status of each of the one or more first repeaters to indicate a processed state. Process 1100 may proceed from 1130 to 1140.

At 1140, process 1100 may involve processor 910 transmitting, via communication device 930, an address of a target repeater to each of the one or more first repeaters such that each of the one or more first repeaters is connected to the target repeater. In some implementations, apparatus 900, as the master node, may be the target repeater.

In some implementations, process 1100 may involve processor 910 performing additional operations. For instance, process 1100 may involve processor 910 parsing a remainder of the list of the plurality of repeaters each of which having a status indicating the unprocessed state to identify one or more second repeaters of the plurality of repeaters such that a respective signal strength between each of the one or more second repeaters and a respective one of the one or more first repeaters is greater than a second threshold different from the first threshold. Additionally, process 1100 may involve processor 910 setting the status of each of the one or more second repeaters to indicate the processed state. For each of the one or more second repeaters, process 1100 may involve processor 910 transmitting, via communication device 930, an address of the respective one of the one or more first repeaters such that each of the one or more second repeaters is connected to the respective one of the one or more first repeaters.

In some implementations, process 1100 may involve processor 910 performing additional operations. For instance, process 1100 may involve processor 910 parsing a remainder of the list of the plurality of repeaters each of which having a status indicating the unprocessed state to identify at least a third repeater of the plurality of repeaters such that a respective signal strength between the third repeater and the master node is greater than a respective signal strength between the master node and each of a remainder of the list of the plurality of repeaters each of which having the status indicating the unprocessed state. Additionally, process 1100 may involve processor 910 setting the status of the third repeater to indicate the processed state. Moreover, process 1100 may involve processor 910 transmitting, via communication device 930, an address of a respective one of the one or more first repeaters, a respective one of the one or more second repeaters or the master node to the third repeater such that the third repeater is connected to the respective one of the one or more first repeaters or the respective one of the one or more second repeaters. Step 2 of logic flow 500 may be repeated.

In some implementations, process 1100 may involve processor 910 performing additional operations. For instance, process 1100 may involve processor 910 parsing a remainder of the list of the plurality of repeaters each of which having a status indicating the unprocessed state to identify at least a fourth repeater of the plurality of repeaters such that a respective signal strength between the fourth repeater and the master node is greater than a respective signal strength between the master node and each of a remainder of the list of the plurality of repeaters each of which having the status indicating the unprocessed state. It is noteworthy that Step 4 of logic flow 500 is for those repeaters to which master node is not visible. In this case, RSSI of all unprocessed repeaters may be checked with all the processed repeaters, and one unprocessed repeater may be identified as having the best RSSI with the processed repeaters. This identified unprocessed repeater may be marked as processed and Step 2 of logic flow 500 may be executed again. Additionally, process 1100 may involve processor 910 setting the status of the fourth repeater to indicate the processed state. Furthermore, process 1100 may involve processor 910 transmitting, via communication device 930, an address of a respective one of the one or more first repeaters, a respective one of the one or more second repeaters, or the third repeater to the fourth repeater such that the fourth repeater is connected to the respective one of the one or more first repeaters, the respective one of the one or more second repeaters, or the third repeater.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
triggering regrouping of a plurality of repeaters by:
transmitting, by a master node, a discovery request to a plurality of repeaters in a network of a first topology to cause each repeater of the plurality of repeaters to conduct a scan to detect signal strengths of other repeaters of the plurality of repeaters;
receiving, by the master node, information on results of the scan from each repeater of the plurality of repeaters; and
directing, by the master node based on the received information, the plurality of repeaters to form a network of a second topology different from the first topology.

2. The method of claim 1, wherein the receiving of the information on the results of the scan from each repeater of the plurality of repeaters comprises receiving, from each repeater, information on received signal strength indication (RSSI) between the respective repeater and each of one or more other repeaters of the plurality of repeaters.

3. The method of claim 1, wherein the directing of the plurality of repeaters to form the network of the second topology comprises, for a respective repeater of the plurality of repeaters, performing operations comprising:
identifying a target repeater among the plurality of repeaters to which the respective repeater is to connect; and
transmitting an address of the target repeater to the respective repeater such that, upon receiving the address of the target repeater, the respective repeater establishes a connection to the target repeater.

4. The method of claim 3, wherein the identifying of the target repeater comprises selecting the target repeater among the plurality of repeaters based on a signal strength between the target repeater and the respective repeater, a number of hops between the respective repeater and the master node in the second topology, or both.

5. The method of claim 1, wherein the triggering of the regrouping of the plurality of repeaters comprises one of:
automatically triggering the regrouping by the master node;
receiving, by the master node, a signal from an application executed on a client device such that the signal causes the master node to trigger the regrouping; or
receiving, by the master node, a user command from a user of the client device that instructs the master node to regroup the plurality of repeaters to form the network in the second topology.

6. The method of claim 5, further comprising:
transmitting, to the client device by the master node prior to directing the plurality of repeaters to form the network of the second topology, topology information of the first topology which is displayable on the client device; and
transmitting, to the client device by the master node after directing the plurality of repeaters to form the network of the second topology, topology information of the second topology which is displayable on the client device,
wherein the triggering of the regrouping of the plurality of repeaters comprises receiving the signal from the application executed on the client device or receiving the user command from the user of the client device.

7. A method, comprising:
setting a status of each of a plurality of repeaters to indicate an unprocessed state;
parsing a list of the plurality of repeaters to identify one or more first repeaters of the plurality of repeaters such that a respective signal strength between each of the one or more first repeaters and a master node is greater than a first threshold;
setting the status of each of the one or more first repeaters to indicate a processed state; and
transmitting an address of a target repeater to each of the one or more first repeaters such that each of the one or more first repeaters is connected to the target repeater.

8. The method of claim 7, wherein the target repeater comprises the master node.

9. The method of claim 7, further comprising:
parsing a remainder of the list of the plurality of repeaters each of which having a status indicating the unprocessed state to identify one or more second repeaters of the plurality of repeaters such that a respective signal strength between each of the one or more second repeaters and a respective one of the one or more first repeaters is greater than a second threshold different from the first threshold;
setting the status of each of the one or more second repeaters to indicate the processed state; and
for each of the one or more second repeaters, transmitting an address of the respective one of the one or more first repeaters such that each of the one or more second repeaters is connected to the respective one of the one or more first repeaters.

10. The method of claim 9, further comprising:
parsing a remainder of the list of the plurality of repeaters each of which having a status indicating the unprocessed state to identify at least a third repeater of the plurality of repeaters such that a respective signal strength between the third repeater and the master node is greater than a respective signal strength between the master node and each of a remainder of the list of the plurality of repeaters each of which having the status indicating the unprocessed state;
setting the status of the third repeater to indicate the processed state; and
transmitting an address of a respective one of the one or more first repeaters or a respective one of the one or more second repeaters to the third repeater such that the third repeater is connected to the respective one of the one or more first repeaters or the respective one of the one or more second repeaters.

11. The method of claim 10, further comprising:
parsing a remainder of the list of the plurality of repeaters each of which having a status indicating the unprocessed state to identify at least a fourth repeater of the plurality of repeaters such that a respective signal strength between the fourth repeater and the master node is greater than a respective signal strength between the master node and each of a remainder of the list of the plurality of repeaters each of which having the status indicating the unprocessed state;
setting the status of the fourth repeater to indicate the processed state; and
transmitting an address of a respective one of the one or more first repeaters, a respective one of the one or more second repeaters, or the third repeater to the fourth repeater such that the fourth repeater is connected to the respective one of the one or more first repeaters, the respective one of the one or more second repeaters, or the third repeater.

12. An apparatus, comprising:
a communication device capable of wireless communications with a plurality of repeaters in a network of a first topology; and
a processor coupled to the communication device, the processor capable of regrouping the plurality of repeaters to form a network of a second topology different from the first topology.

13. The apparatus of claim 12, wherein, in regrouping the plurality of repeaters, the processor performs operations comprising:
transmitting, via the communication device, an initiating request and a discovery request to the plurality of repeaters to cause each repeater of the plurality of repeaters to conduct a scan to detect signal strengths of other repeaters of the plurality of repeaters;
receiving, via the communication device, information on results of the scan from each repeater of the plurality of repeaters; and
directing, via the communication device, the plurality of repeaters to form the network of the second topology based on the received information,
wherein the information on the results of the scan received from each repeater of the plurality of repeaters comprises information on received signal strength indication (RSSI) between the respective repeater and each of one or more other repeaters of the plurality of repeaters.

14. The apparatus of claim 13, wherein, in directing the plurality of repeaters to form the network of the second topology, the processor performs, for a respective repeater of the plurality of repeaters, operations comprising:
identifying a target repeater among the plurality of repeaters to which the respective repeater is to connect; and
transmitting an address of the target repeater to the respective repeater such that, upon receiving the address of the target repeater, the respective repeater establishes a connection to the target repeater,
wherein, in identifying the target repeater, the processor selects the target repeater among the plurality of repeaters based on a signal strength between the target repeater and the respective repeater, a number of hops between the respective repeater and the master node in the second topology, or both.

15. The apparatus of claim 12, wherein the processor is capable of regrouping the plurality of repeaters as a result of:
automatic triggering of the regrouping by the processor;
receiving, via the communication device, a signal from an application executed on a client device that is communicatively connected to the processor such that the signal causes the processor to trigger the regrouping; or
receiving, via the communication device, a user command from a user of the client device that instructs the processor to regroup the plurality of repeaters to form the network in the second topology.

16. The apparatus of claim 15, wherein the processor is further capable of performing operations comprising:
transmitting, to the client device via the communication device prior to directing the plurality of repeaters to form the network of the second topology, topology information of the first topology which is displayable on the client device; and
transmitting, to the client device via the communication device after directing the plurality of repeaters to form the network of the second topology, topology information of the second topology which is displayable on the client device,
wherein the regrouping of the plurality of repeaters is triggered by receiving the signal from the application executed on the client device or receiving the user command from the user of the client device.

17. The apparatus of claim 12, wherein, in regrouping the plurality of repeaters, the processor is capable of performing operations comprising:
setting a status of each of the plurality of repeaters to indicate an unprocessed state;
parsing a list of the plurality of repeaters to identify one or more first repeaters of the plurality of repeaters such that a respective signal strength between each of the one or more first repeaters and a master node is greater than a first threshold;
setting the status of each of the one or more first repeaters to indicate a processed state; and
transmitting an address of a target repeater to each of the one or more first repeaters such that each of the one or more first repeaters is connected to the target repeater.

18. The apparatus of claim 17, wherein, in regrouping the plurality of repeaters, the processor is further capable of performing operations comprising:
parsing a remainder of the list of the plurality of repeaters each of which having a status indicating the unprocessed state to identify one or more second repeaters of the plurality of repeaters such that a respective signal strength between each of the one or more second repeaters and a respective one of the one or more first repeaters is greater than a second threshold different from the first threshold;
setting the status of each of the one or more second repeaters to indicate the processed state; and
for each of the one or more second repeaters, transmitting an address of the respective one of the one or more first repeaters such that each of the one or more second repeaters is connected to the respective one of the one or more first repeaters.

19. The apparatus of claim 18, wherein, in regrouping the plurality of repeaters, the processor is further capable of performing operations comprising:
parsing a remainder of the list of the plurality of repeaters each of which having a status indicating the unprocessed state to identify at least a third repeater of the plurality of repeaters such that a respective signal strength between the third repeater and the master node is greater than a respective signal strength between the master node and each of a remainder of the list of the plurality of repeaters each of which having the status indicating the unprocessed state;
setting the status of the third repeater to indicate the processed state; and
transmitting an address of a respective one of the one or more first repeaters or a respective one of the one or more second repeaters to the third repeater such that the third repeater is connected to the respective one of the one or more first repeaters or the respective one of the one or more second repeaters.

20. The apparatus of claim 19, wherein, in regrouping the plurality of repeaters, the processor is further capable of performing operations comprising:
parsing a remainder of the list of the plurality of repeaters each of which having a status indicating the unprocessed state to identify at least a fourth repeater of the plurality of repeaters such that a respective signal strength between the fourth repeater and the master node is greater than a respective signal strength between the master node and each of a remainder of the list of the plurality of repeaters each of which having the status indicating the unprocessed state;
setting the status of the fourth repeater to indicate the processed state; and
transmitting an address of a respective one of the one or more first repeaters, a respective one of the one or more second repeaters, or the third repeater to the fourth repeater such that the fourth repeater is connected to the respective one of the one or more first repeaters, the respective one of the one or more second repeaters, or the third repeater.
